(19) United States
(12) Patent Application Publication
(10) Pub. No.: US 2023/0158766 A1
(43) Pub. Date: May 25, 2023

(54) METHOD OF MONITORING A HIGH-PRESSURE ROLLER PRESS

(71) Applicant: MASCHINENFABRIK KÖPPERN GMBH & CO. KG, Hattingen (DE)

(72) Inventors: Max BUCHMEIER, Wuppertal (DE); Eggert DE WELDIGE, Velbert Langenberg (DE)

(21) Appl. No.: 17/919,979

(22) PCT Filed: May 28, 2021
(86) PCT No.: PCT/EP2021/064345

§ 371 Date: Oct. 19, 2022

(30) Foreign Application Priority Data
Jun. 4, 2020 (DE) 10 2020 114 815.1

(51) Int. Cl. B30B 15/00; B02C 4/28; B02C 4/02; B02C 25/00; B30B 3/04

(52) U.S. Cl. CPC B30B 15/0094; B02C 4/28; B02C 4/02; B02C 25/00; B30B 3/04; B30B 15/0005

(57) ABSTRACT

The invention relates to a method for monitoring a high-pressure roller press in the course of comminuting, compacting, or briquetting material. The roller press has two rotationally driven press rollers, between which a rolling gap is formed with a gap width that can be modified during operation. During operation, operational data of the roller press is ascertained by one or more measurement value sensors and is stored on a computer. The method is characterized in that the operational data is stored as raw data on an edge computer, as an analysis computer, which is stationed locally in the region of the roller press and is connected to the measurement value sensors, and the raw data is evaluated on the analysis computer using an analysis algorithm so that characteristic data of the roller press is generated and stored on the analysis computer, wherein the characteristic data is transmitted from the analysis computer to at least one terminal via a wireless network and is displayed on the terminal.

The invention relates to a method of monitoring (the state/operating state) of a high-pressure roller press when comminuting, compacting or briquetting material, wherein

the roller press has two rotationally driven press rolls, forming a roll gap whose gap width is variable during operation,

operating data of the roller press are determined and stored on a computer during operation with one or more sensors.

Such a high-pressure roller press for comminuting material is also referred to as a material bed roll mill. However, the invention also relates to high-pressure roller presses for compacting or briquetting material. The material is in particular highly abrasive material, for example ore, cement clinker, slag or ceramic base materials. The roller press can also be used for compacting for example fertilizers. One of the press rolls is preferably a fixed roll and is consequently rotatably mounted in a press frame in a stationary manner. At least one press roll is a movable roll, i.e. it can be adjusted relative to the other roll, for example the fixed roll, by an actuator, for example by hydraulic cylinders, with a variable gap width during operation.

The two press rolls are driven in opposite directions (synchronously) via drives. The gap between the rolls, as a result of the described positioning of the movable roll against the fixed roll. is set until a pressure corresponding to the setting forces acts between the rolls. The gap width is obtained in this case, the ratio of the setting forces to the reaction forces originating from the material to be processed. Each press roll has for example a rotatably driven roll core and a jacket that is fastened to the roll core and that forms the (wear-resistant) surface of the roll. The jacket can be a completely circumferential (one-piece) ring or alternatively can be formed by a plurality of segments fastened to the core. However, it is also possible to press rolls or working rolls are used that are not formed with separate jackets, but rather for example as one piece or in a segmented manner. The press rolls always have a (wear-resistant) outer roll surface as the working surface.

In practice, it is customary to monitor, control and optionally display the state or operating condition of a high-pressure roller press continuously or quasi-continuously. For this purpose, the roller press is provided with measured value pick-ups that receive various operating data of the roller press, which can be stored in the prior art for example on a computer and/or displayed in a control room of the plant. Thus for example the torque of the press rolls, the hydraulic pressures in the cylinders of the movable roll and the gap width are measured with suitable detectors or sensors in turn connected for example to a controller, for example a programmable logic controller (SPS) that in turn is connected to a control room of the system or to a computer arranged in the control room.

DE 101 06 856 describes a high-pressure roller press for a material bed is known in which, during operation, the drive and movement parameters of at least one roll are measured as control parameters, the ratio of these values to one another being formed and this ratio being always kept substantially constant by reducing or increasing the roller pressing force of the rolls. For this purpose for example the drive power of a main motor and the circumferential speed of the rolls are measured during operation and the ratio of this is used as a controlled variable.

DE 4226182 describes a high-pressure roller press in which the bearing blocks of the movable roll are braced against hydraulic cylinders of a hydropneumatic system and sensors are provided for measuring the width of the roll gap that is established at the two roll sides during operation. The sensors measure the distance between the bearing blocks of the two rolls and the signals obtained are fed via lines to the inputs of a monitoring and control device. The spacing between the bearing blocks that occurs during operation of the machine and thus also the width of the roll gap occurring during operation at both roll sides is measured continuously or temporally in a clocked manner by the sensors, and the difference between the two measured values is calculated and compared with a predetermined tolerance value. If, in the case of an unsymmetrical load of the roll gap for example the bearing block of the movable roll moves inward and there is an oblique position of the movable roll with an exceeding of the predetermined tolerance value, a control intervention takes place via the central monitoring and controller, specifically in this case relating to the correction of the roll gap by adjusting actuating motors for metering flaps on the feed shaft.

Monitoring the operating state of rotating rolls in an industrial plant is also described for example in WO 2007/025395, specifically for mills for grain processing. In this case, vibrations are monitored and a time-variable electrical signal is generated therefrom and is subjected to a frequency analysis. The vibrations can be detected for example by an accelerometer mounted on the bearing of the rotating roll. The analysis can be carried out with a computer that can also be integrated into a control system of an automated industrial plant that can also have monitoring screens for displaying for example the operating state. The industrial plant can also have a plurality of rotating rolls and a plurality of systems and the individual systems are networked to one another and to a monitoring center, for example wirelessly cross-linked.

WO 2018/036978 [U.S. Pat. No. 11,065,626] describes a self-optimizing, adaptive production=-processing system having a grinding system that includes a roller press and at least one sensor for detecting measured values relating to a state of at least one roll is provided, so that measured values that characterize a state of the roll are detected. A data receiver of a controller of the production processing system takes in from a data transmitter of the measuring device of at least one roll. In this case, the roll operation and the width of the gap between the rolls and/or the parallelism of the rolls are automatically optimized by the controller or by a control device connected to the controller on the basis of the received measured values.

DE 10 200 7 004 004 discloses a roll mill with two counter-driven grinding rolls and that is provided with pin-shaped profile bodies and in which an autogenous wear protection layer is formed. The roll mill has a monitoring device that checks the state of wear of the pin-shaped profile bodies and the state of the autogenous wear protection layer and moreover also determines the presence or absence of the pin-shaped profile bodies. For this purpose, the roll mill can have at least one sensor that can be provided so as to be movable with respect to the grinding roll.

Monitoring the operating state of machines is also described for example in WO 2017/197449 [US 2019/0187679] and a plurality of parameters of the machine are measured and thus measured values are made available and normalized indicator values are generated from these measured values and these standardized indicator values are used for describing the state of the machine. In this case, machine modules corresponding to individual machines can be assigned that are each provided with a computer. The individual machine modules can be connected to a common plant module via a network. Moreover, machine modules of different installations can also be connected directly to a central monitoring system that collects sensor data of a plurality of machine modules of a plurality of installations that may optionally also be geographically distributed, so that methods of the “Internet of Things” are resorted to.

US 2005/0049801 relates to monitoring machines with movable components and a locally arranged analysis computer at the machines that can record and evaluate measurement values. The evaluated data can be transmitted to a physically remote external computer.

DE 10 200 8 046 921 [U.S. Pat. No. 8,590,391] describes a method of monitoring the load state of a grinding installation with rotating grinding elements. In addition to monitoring the dynamic force acting on the grinding member, monitoring of the drive torque determined from power and rotational speed also takes place.

Finally, WO 2018/036978 [U.S. Pat. No. 11,065,626] discloses a monitoring and controller for the automated optimization of the grinding line of a roll system and a corresponding method.

Overall, there is a need in machine and plant technology to monitor and display the state of machines. In practice, this takes place in connection with high-pressure roller presses as a rule via the detection of the sensor data by conventional memories of programmable controls that are connected to a control room of the installation.

Moreover, so-called superordinate solutions are known in which operating data of machines are stored centrally, for example in the cloud and are optionally evaluated, so that the data can be accessed via the Internet with different terminals, for example laptops, tablets or smart phones.

Proceeding from the known prior art, the invention is based on the technical problem of providing, in connection with high-pressure rolls that are intended for the comminution, compaction or briquetting of material, a method that enables a simple, reliable and reliable monitoring of a state or operating state of the high-pressure roller press.

In order to achieve this object, the invention teaches in a generic method of monitoring a high-pressure roller press of the type defined above, that

the operating data (that are determined with the measuring value pick-up or sensors) are stored as raw data on a local edge computer on or adjacent the roller press and connected to the roller press or to the sensor or sensors,

the operating data or raw data are evaluated on the analysis computer with analysis algorithms and thus characteristic data of the roller press are generated and these characteristic data are stored on the analysis computer,

the characteristic data are transmitted from the analysis computer via a wireless network (i.e. wirelessly) to at least one terminal and displayed or displayed on the terminal.

The analysis computer or edge computer is preferably hard wired by at least one connecting cable to the measurement value pick-up or sensors on the roller press.

The invention is based on the discovery that it is advantageous to first store the operating data determined with the sensors as raw data on a powerful edge computer that is positioned locally in the immediate vicinity of the roller press and is particularly preferably connected by hard wiring to the sensors. However, this edge computer not only serves to store the operating data as raw data, but also the analysis or evaluation of the raw data takes place with corresponding algorithms that are stored directly on the edge computer.

Storage of the operating data or raw data in a higher-level network or in the cloud is dispensed with as well as transmission of the raw data via the Internet. Rather, an analysis with suitable algorithms and storage of the (compressed) characteristic data generated from these raw data with the aid of the algorithms are already carried out locally, and are collected for example in a database on the analysis computer and from there can for example be made available for retrieval by a terminal. The raw data are preferably stored redundantly on local storage media, for example hard disks of the edge computer. In this case, in principle known and available hardware can be resorted to, that is to say it is possible to use powerful edge computers to store large data amounts of and to use powerful processors and the basic setups of “edge computing” known in principle can be used.

For determining and storing the operating data, a multiplicity of fundamentally known sensors can be used in or on the press, for example measured value detectors or sensors for determining the torque of one or both rolls, of the hydraulic pressure in or in the cylinders for setting the movable roll, position sensors and/or travel sensors for determining the gap width of the roll gap and/or for determining the absolute position of the movable roll or the position of the movable roll relative to a stationary press frame and position sensors are arranged for example at the bearings of the movable roll and/or the fixed roll. Additionally or alternatively, temperature sensors, flow sensors, etc. can be used. The sensors can provide analog measurement values, for example as current signals that are associated with a suitable detection direction, for example are converted into digital data via a converter, so that digital raw data are stored on the edge computer. It is important that the processing and analysis of the raw data are carried out on the local analyzer (“edge computing”). Alternatively, however, sensors with a digital output can also be used to output the signal for example as a coded pulse sequence.

The characteristic data of the roller press generated by the application of the stored algorithms on the edge computer can be used online via a wireless network, for example via the Internet, or can be transmitted via the wireless network (wirelessly) to terminals. The terminals can be for example external PCs, notebooks, tablets or smart phones. It is self-evident that access to the characteristic data for the purpose of information or display on the terminal is possible only by appropriate access authorization. In a preferred embodiment, the edge computer is connected to a router, for example a commercial-grade router, via which a connection to a wireless network, for example to the Internet, is established, so that online access to the characteristic data stored in the database on the edge computer is possible. In a preferred development, the retrieval or access is not carried out directly via the commercial-grade router, but via an external portal that is connected wirelessly, for example via a VPN (virtual private network) connection to the commercial-grade router. It is thus possible for example to access the portal via suitable terminals with an https connection and transmit the characteristic from there (via VPN) via the commercial-grade router. Optionally, there is also the possibility for example of connecting a computer for remote maintenance via a VPN network to the portal. Via simple https connections, there is generally only the possibility of retrieving the characteristic data and consequently displaying information on the terminal via simple https connections. Via the VPN connection, it is possible for example to access the edge computer in the sense of remote maintenance. It is self-evident for the portal and the terminals that access rights are assigned and the comprehensibility of the accesses is registered by protocols.

Directly specific data of the machine, for example the roll gap, the power consumption or the like, can be displayed and displayed directly as characteristic data. Alternatively or additionally, statistical evaluation can be made available as characteristic data, for example weekly or monthly reports about the machine states.

In a particularly preferred embodiment, however, the characteristic data are not simple machine data or evaluated or compressed measurement data that relate directly to a measurement variable of a sensor (for example power, gap width or the like), but particularly preferably special states, for example critical states, are determined and displayed or evaluated via corresponding algorithms.

The operating data and consequently the raw data are preferably recorded at a high sampling rate of more than 50 Hz, for example more than 100 Hz, preferably at least 200 Hz and stored on the analysis computer. The invention is based on the recognition that the programmable controllers (SPS) that are usually used in practice and that are connected to the sensors as a rule do not have the measurement data at a high speed or a high sampling rate forwarded by the sensors preferably without an interposed PLC directly to the edge computer or to an evaluation unit that is connected to the edge computer or integrated into the edge computer and is suitable for recording and storing the operating data at the high sampling rate. Fifty Hz means that 50 measured values per second (i.e. a measured value of 20 ms) is made available. The invention has recognized that certain operating states, interference states or critical states can be determined only when the operating data are made available at a correspondingly high sampling rate. This results in extremely large amounts of data. However, since these are stored locally and in a hard-wired system on the edge computer directly on site, these quantities of data can be handled without problems. Transmission via a wireless network is not necessary for this large amount of raw data, since the large amounts of data are initially compressed by suitable evaluations on the edge computer, so that the user only has to access the compressed or evaluated data via a wireless network. In principle, there is the possibility of only one measured value (or record type) as raw data and the determination therefrom with an analysis algorithm of one or more characteristic data. Preferably, however, a plurality of different operating data are recorded as raw data and evaluated with an analysis algorithm in the sense of a linking evaluation.

The recording of the measured values with a high sampling rate is of particular importance for example in the detection of a foreign body passage through the roll gap. Thus, the invention has recognized that an analysis of the high-frequency recorded operating data surprisingly allows a foreign body passage through the nip of the floating-pressure roller press to be established, specifically in particular when a plurality of (different) measured values are recorded and evaluated as raw data and the characteristic data are determined by linking the signals or raw data by an algorithm. In this case, in particular the torque of a press roll or the torques of both press rolls can be used as operating data. As a rule, the torques during operation of the press rolls remain constant within certain limits. The roll gap is also kept substantially constant by the type of adjustment of the movable roll described above. This is because in a high-pressure roller press, for example a material bed roll mill, the supplied particles of the feed material are not broken as in the case of a comminutor between the surfaces of the two rolls, but rather are pressed in a material bed under high pressure and are thus comminuted or agglomerated in a highly efficient manner. The roll gap is consequently larger than the material that is guided through the roll gap and is to be treated. Surprisingly, it has been found that the signals or signal changes of suitable operating data (for example torque, hydraulic pressure and/or gap width) can be detected despite the very high inertia of the rotating masses and despite the weight of the rolls and in particular of the movable roll and in spite of the friction between the roll bearing and the frame specifically preferably according to the invention due to the high sampling rates and, in a further preferred embodiment, by linking a plurality of signals or a plurality of different operating data by suitable algorithms. Thus, the invention has determined for example by evaluating the raw data recorded at high frequency, that during the passage of foreign bodies it briefly leads to an increase in the torque on a roll or on both rolls. With the memory-programmable controls used hitherto in practice and the provided display tools on the control computer, such short-term torque fluctuations has hitherto not been recognized. By a suitable algorithm, however, the edge computer can now determine passage of a foreign body on the basis of the raw data recorded at high frequency, so that foreign body passages can be counted in a simple manner, for example. In principle, there is the possibility of taking up and evaluating only the torque of one or both rolls as raw data. Particularly preferably, in addition to the torque further operating data are recorded and evaluated, for example the gap width at one or more gap positions and/or the hydraulic pressure of one or more hydraulic cylinders with which the movable roll is urged toward the fixed roll. The evaluation and for example foreign body recognition can consequently be considerably improved by combined or linked evaluation of a plurality of measured values (or a plurality of measured value types). The described advantages can likewise be realized in various types of machines, for example roll mills, briquetting machines and compacting machines.

The operating data for the torque is not accessed via the terminals for example, but rather only as the result of the evaluation and consequently to the counted or summed foreign body passes, or a message can be sent to a terminal when a foreign body passage has been registered. Thus for example a further evaluation of the foreign body passages can take place, so that for example foreign body passages, irregularities or the like that occur again in time can be analyzed and determined. Thus for example a conclusion can be drawn about the operation of upstream or other plant components, for example an upstream comminutor. If it is for example the case of an upstream comminutor, in particular for temporary disturbances, the loading of the press can be increased with undesirably large parts and this would in turn be determined by the foreign-body detection.

Overall, the design according to the invention achieves an optimization of the processes from the point of view of the “Industry 4.0” or “Internet of Things.” The roller press can be extended to a “talking machine.” In this case, programmed algorithms are used and algorithms or methods of artificial intelligence (“AI”) and consequently self-learning or self-learning algorithms are also used.

The described high-frequency sampling of the torque as described is merely an example of the data analysis according to the invention, for example for monitoring foreign body passage through the roll gap. Alternatively, another measured value can also be analyzed and evaluated for this purpose. Thus, it is also possible to evaluate the hydraulic pressure at the hydraulic cylinders at a high frequency, to act on the movable roll. Short-term fluctuations from a foreign body passage can also be evaluated by such an evaluation. The evaluation result can be further improved by analyzing a first operating parameter in combination with a second operating parameter and drawing conclusions about the respective event by an algorithm. In particular, it may be expedient to combine the development of the torque with a measurement of the roll gap. In the same way, a measurement of the hydraulic pressure with the roll gap can also be combined.

Another example of monitoring a state of the roller press according to the invention is monitoring the wear state of the roll surfaces (for example the jackets) of the high-pressure roller press. Since the usually recorded roll gap is adjusted with the aid of the hydraulic cylinders in such a way that it is kept constant during operation in a large and complete manner, it is not possible to determine the wear state of the rolls by the detection of the roll gap whose roll surfaces (for example jackets) touch. According to a further proposal of the invention, it is therefore provided that the position of the movable roll is recorded as a function of time with one or more position sensors and the data on the analysis computer can be stored. With an algorithm, the wear state of the roll surface can be determined from the measured data and a prediction for the remaining service life of the roll surface can be generated. The position sensors preferably detect the position of the bearing points of the movable roll and in this embodiment an absolute measurement of the position of the movable roll or bearing points thereof is meant, i.e. determining the position relative to a stationary reference system, for example the press frame. While the gap width of the press nip should essentially not change or change during operation, since, as the roll surface/jacket wears, the movable roll is always advanced toward the fixed roll, the wear of the roll surfaces can be determined very simply on the basis of the changing position of the movable roll. This is because with increasing wear of the roll surfaces and consequently with decreasing working roll diameter, the movable roll is always placed further against the fixed roll, so that the position of the bearing points of the movable roll always approaches the position of the bearings of the fixed roll. The position of the bearing points of the movable roll is consequently a good measure of the decrease in the roll diameter and thus for the wear state of the roll surfaces. With the aid of an algorithm, a prediction for the remaining service life of the roll or roll surfaces can be generated on the basis of data or empirical values previously made available. In this way, maintenance predictions (predictive maintenance) can be created with the invention.

The subject matter of the invention is not only the described method, but also an installation for comminuting, compacting or briquetting material according to claim 10. Consequently, not only the method but also a system is provided that has an edge computer of the type described and this edge computer is provided with corresponding programs for the data processing and/or algorithms that are set up to carry out the described method.

The invention is explained in more detail below with reference to drawings showing embodiments by way of example. Therein:

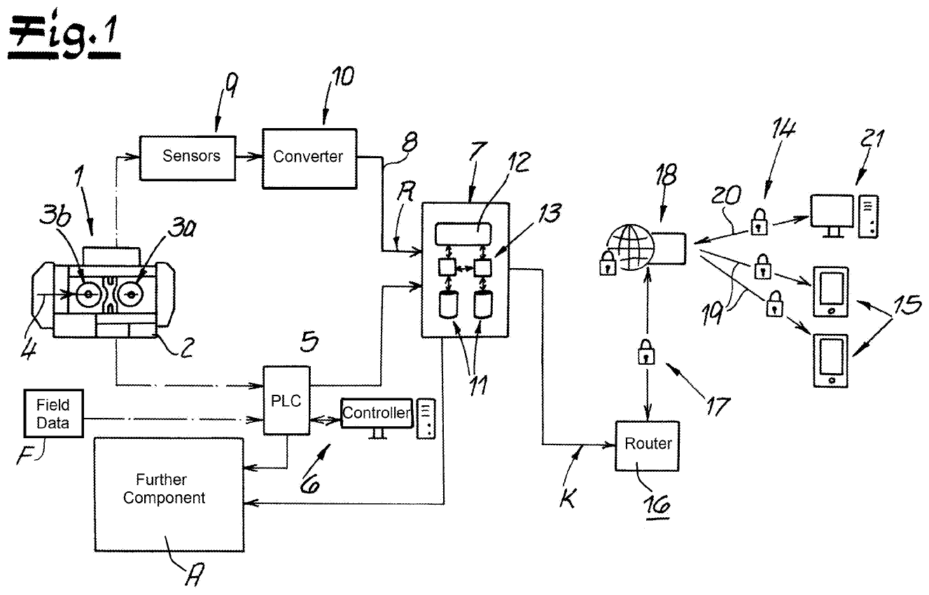

FIG. 1 is a schematic greatly simplified diagram of a system according to the invention with a roller press,

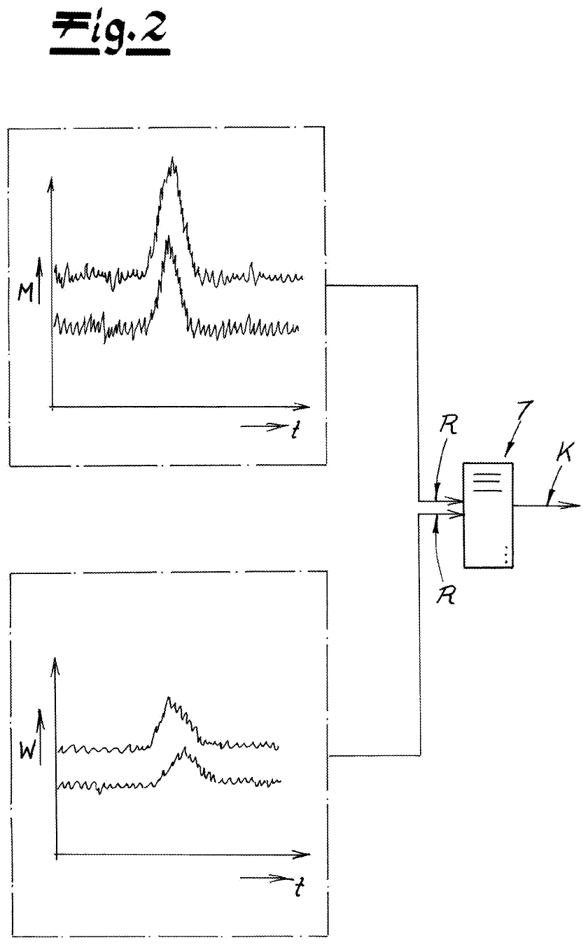

FIG. 2 are graphs of the torque and gap-width raw data compared to time, and

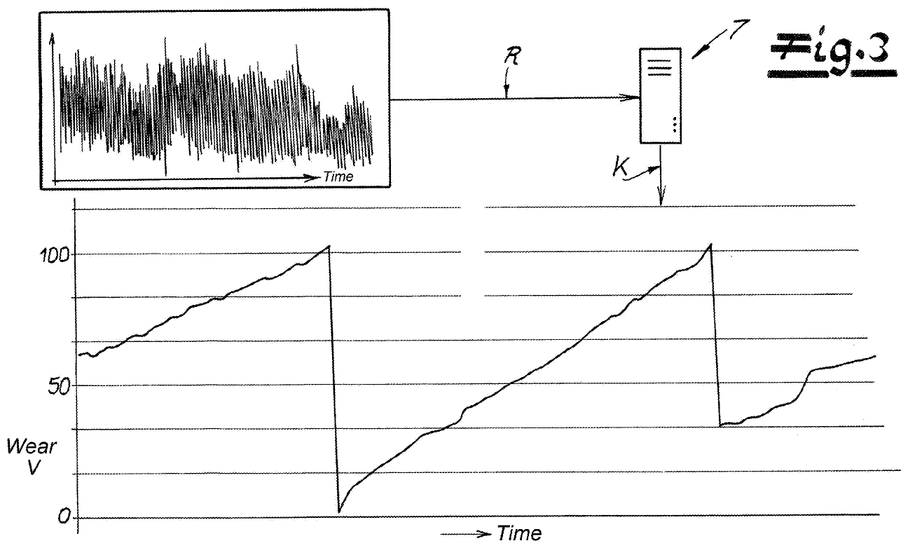

FIG. 3 is a view of the movable roll position and the wear state for maintenance prediction.

FIG. 1 shows, for example, a system for monitoring a condition of a high-pressure roller press 1 and this high-pressure roller press 1 is intended for example for comminuting granular material, alternatively also for compacting or briquetting material. The roller press has a press frame 2 and two press rolls 3a and 3b that are rotatably mounted in the press frame 2 and are driven in opposite directions. A roll gap whose gap width is variable during operation, is formed between the press rolls. This is because one of the two press rolls is a fixed roll 3a mounted in a stationary manner in the press frame 2, and the other press roll is a movable roll 3b and this movable roll can be urged toward the fixed roll 3a via biasing means, for example via hydraulic cylinders 4, so that the gap width of the roll gap can change during operation. During operation, the roll gap adjusts itself as a function of the setting forces of the movable roll against the fixed roll until an equivalent pressure acts between the rolls. Each of the two press rolls 3a and 3b can be a solid roll or segmented roll or preferably on the one hand has a driven roll core and on the other hand a jacket (for example annular jacket) on the roll core that is equipped for example with a wear-resistant surface. Details are not shown in the figures.

Such a roller press 1 can be connected in a conventional manner to a programmable logic controller or PLC 5 that in turn can be connected to a higher-level plant controller or control room 6. The operation of the roller press 1 can be controlled and monitored in a known manner via the guide plate 6. For this purpose, the PLC 5 can be connected on the one hand to the drives of the roller press and on the other hand to different sensors.

According to the invention, however, as an alternative or in addition to the programmable logic controller 5, a special computer is provided, namely an edge computer as an analysis computer 7 that is hard wired via one or more connecting cables 8 to sensors 9 of the roller press. This edge computer or analysis computer 7 is locally stationary in the immediate vicinity of the roller press. The operating data registered with the sensors 9 are stored as raw data on this analysis computer 7. For this purpose, the sensors 9 may be provided with (additional) measuring devices or measuring cards 10, with which the analog measurement data are converted into digital operating data R. Optical connecting cables for example can preferably be connected to the analysis computer 7 for the connection of the measuring card 10 and fiber optic cable for particularly fast data transmission are used. The analysis computer 7 is provided as an edge computer with considerable memory 11, processors 12 and specially designed algorithms 13 for the analysis and evaluation of the operating data. Several memories 11 for redundant data storage are preferably provided in the analysis computer 7. The raw data R are stored on the analysis computer 7 and evaluated with the analysis algorithms 13 and thus characteristic data K of the roller press 1 are generated, which are likewise stored on the analysis computer. According to the invention, these characteristic data K are transmitted from the analysis computer 7 via a wireless network 14 to one or more terminals 15, for example PCs, tablets, smart phones or the like, i.e. the characteristic data K can be accessed via the terminals 15. It is of particular importance here that correspondingly authorized users have access to the already evaluated characteristic data K via the terminals 15 and not to the very extensive raw data. For this purpose, the characteristic data K can be stored in the analysis computer 7 in for example a database as compressed data and provided in the database for online access via PC, smart phone or the like, for example for corresponding plant status displays.

In this case, the operating data R can be recorded in a conventional manner with known measurement value sensors 9 provided in any case at the roller press, specifically for example the torque of a press roll or of both press rolls, the hydraulic pressure of the hydraulic cylinders for the application of the movable roll, position sensors for determining the variable roll gap, position sensors for determining the absolute position of the movable roll, or the position of the movable roll relative to the stationary press frame, weighing cells, temperature sensors, flow sensors or the like. The respective state of the roller press 1 or values of these sensors 9 can be displayed in compressed form via the terminals 15 in a simple manner, so that current machine status can be displayed. Alternatively, statistical evaluations can be queried on the terminal 15 that, however, are not generated on the terminal 15, but rather on the analysis computer 7, for example individual week reports, month reports or the like. Particularly preferably, however, interference conditions, exceptional conditions or the like can be monitored using the method according to the invention.

For this purpose, it is particularly advantageous if the operating data are recorded as raw data R at a high sampling rate of more than 100 Hz, for example more than 200 Hz and stored on the analysis computer 7. This results in large amounts of data that, however, are transmitted directly to the local analysis computer 7 over short distances and are stored there and already evaluated. From the very large quantities of data, the desired characteristic data or characteristic values K are generated by the already mentioned analysis algorithms 13and can be accessed by the terminals 15 via the wireless network 14, for example via the Internet.

FIG. 1 shows that the computer 7 is connected for online access to a commercial-grade router 16 that, in a preferred variant, is connected to a portal 18 via a VPN network or VPN connection 17. The terminals 15 consequently do not access the commercial-grade router 16 directly for a query of the evaluated characteristic data, but via the portal 18, specifically for example via secured or encrypted https connections 19. Otherwise, an additional computer or PC 21 can optionally be connected to the portal 18 via an additional VPN connection 20, so that data is not only queried via this PC for remote maintenance, but can also be accessed on the analysis computer 7 or the roller press.

It is furthermore indicated in FIG. 1 that field data F and consequently data from other components of the plant, for example a grinding system A, can also be detected at the PLC 5 and/or the computer 7, for example operating data of a comminutor.

Finally, data, commands or the like can also be transmitted from the analysis computer 7 to the roller press 1 or other components of the system. For example, the evaluated characteristic data can be used for controlling or control the press or other machines.

Examples of preferred applications of the described system or of the described method are to be explained with reference to FIGS. 2 and 3.

Thus, according to FIG. 2, the torques and/or the gap widths of the two press rolls 3a and 3b can be recorded and evaluated as operating data for monitoring a foreign body passage through the roll gap. In FIG. 2 (as raw data) the torques M of the two rolls on the one hand and the gap widths W (at two different locations of the press gap) on the other hand are plotted as a function of time t, specifically in the case of a foreign body passage through the roll gap. In this case, a high-frequency sampling and storage with for example 200 measured values per second took place in the manner already described. When a passage of a foreign body through the roll gap, a brief increase in the torques M and the gap widths W As can be seen in FIG. 2, such a foreign body passage can be detected and evaluated on the basis of the raw data. However, the fact that the user does not have access to these raw data R, but that an evaluation is already carried out in the edge computer 7 with the analysis algorithms 13, is of interest, so that only a complete foreign body passage has to be stored and displayed as characteristic data K. Consequently, there is the possibility of determining and “counting up” such foreign body passages in the analysis computer by (linking) algorithms. Via the terminals 15, in the sense of a query, foreign body passages determined in a specific period of time can be accessed. Alternatively, it is also possible to send messages to the terminals 15 in the case of a foreign body pass. In principle, the possibility exists for monitoring the foreign body passages (only) to monitor the torques at the two rolls and to evaluate them with an algorithm. In addition, at least one other measured value is preferably also recorded, for example the roll gap and/or the fluid pressure of the hydraulic cylinders for the application of the movable roll. As already described, foreign body passes can be registered particularly preferably by combined or linked evaluation of a plurality of measured values with the aid of the algorithm.

A further application possibility relates to wear monitoring or maintenance predictions, for example monitoring the wear of the jackets of the roller press. For this purpose for example the absolute position of the movable roll 3b is monitored with one or more position sensors. The position of the movable roll 3b relative to a stationary press frame 2 is referred to as the position of the movable roll 3b. For this purpose for example position sensors can be mounted at the bearing points of the movable roll. In FIG. 3 The position of a bearing point as a function of time is shown at the top left. The absolute position of the movable roll 3b is detected by one or more position sensors. The position of the movable roll 3b relative to a stationary press frame 2 is referred to as the position of the movable roll 3b. For this purpose for example position sensors 9 can be mounted at the bearing points of the movable roll 3b. FIG. 2 at the top left shows the position of a bearing point as a function of time t. It can be seen that these raw data R are first picked up at high frequency and stored on the analysis computer 7. The latter generates therefrom the characteristic data K that are plotted in the graph at the bottom. This is a measure of the wear V of the roll surface, for example of the jacket, and it can be seen that this measure increases with increasing operating time, since the working roll diameter, for example the jacket diameter, decreases due to the wear V. If a certain upper limit value is reached, the rolls or roll surfaces, for example the jacket, are exchanged. This can be seen by the abrupt drop at the points shown. While the raw data R actually relate to the position data, the characteristic data K are data that represent the wear state V of the roll surfaces. In this way, maintenance predictions can be made.

1. A method of monitoring a high-pressure roller press when comminuting, compacting or briquetting material, where
the roller press has two rotationally driven press rolls forming a roll gap whose gap width is variable during operation, and
operating data of the roller press are determined and stored on a computer during operation with one or more sensors,
the method comprising the steps of:
storing the operating data as raw data on an edge computer on or adjacent the roller press and serving as an analysis computer is connected to the sensors,
evaluating the raw data on the analysis computer with analysis algorithms and thus characteristic data of the roller press are generated and these characteristic data are stored on the analysis computer,
transmitting the characteristic data from the analysis computer to at least one terminal via a wireless network and displaying the transmitted characteristic data on the terminal.

2. The method according to claim 1, wherein the analysis computer or edge computer is hard wired by at least one connecting cable to the sensors on the roller press.

3. The method according to claim 1, further comprising the step of:
recording the operating data are recorded as raw data with a high sampling rate of more than 50 Hz and storing the recorded operating data on the analysis computer.

4. The method according to claim 1, further comprising the step of:
recording a torque of one or both of the press rolls is recorded and stored as operating data.

5. The method according to claim 1, further comprising the step of:
recording data representing the hydraulic pressure of the biasing means of a press roll or the gap width of the roll gap or the absolute position of a press roll and storing the recorded data as operating data.

6. The method according to claim 1, further comprising the step of:
recording the measured values of different sensors and storing the recorded values as operating data and then evaluating the characteristic data using the analysis algorithms using different operating data of a plurality of sensors and then stored.

7. The method according to claim 1 for monitoring passage of a foreign body through the roll gap is determined by analysis using an algorithm of operating data that changes during the passage of a foreign body through the roll gap as a function of time.

8. The method according to claim 1, further comprising the steps of:
accessing the terminal on a router connected to the analysis computer via a portal connected to the router by a VPN connection.

9. The method according to claim 1, further comprising the steps of:
using the characteristic data for controlling the roller press or another machine within an industrial plant into which the roller press is integrated.

10. A plant for comminuting, compacting or briquetting material with a method according claim 1, the plant comprising at least
a roller press that has two rotatably driven press rolls, forming a roll gap whose gap width is variable during operation,
one or more sensors with which operating data of the roller press are determined,
an edge computer
that is positioned locally at the roller press and is connected to the roller press or to the sensors as an analysis computer on which the operating data is stored as raw data
that applies to the raw data analysis algorithms to generate characteristic data of the roller press that is also stored on the analysis computer, and
that transmits the characteristic data to at least one terminal via a wireless network for display ed on the terminal.
